(19) United States
(12) Patent Application Publication
(10) Pub. No.: US 2013/0236861 A1
(43) Pub. Date: Sep. 12, 2013

(54) PACKAGE FOR CONSUMABLE PRODUCTS

(71) Applicants: Kimberly Ann Wilmers, Twin Lake, MI (US); Cynthia Lynn Wilcox, Newaygo, MI (US)

(72) Inventors: Kimberly Ann Wilmers, Twin Lake, MI (US); Cynthia Lynn Wilcox, Newaygo, MI (US)

(73) Assignee: NESTEC S.A., Vevey (CH)

(21) Appl. No.: 13/518,453

(22) PCT Filed: Jul. 12, 2010
(86) PCT No.: PCT/US10/41711

§ 371 Date: Aug. 29, 2012

Related U.S. Application Data
(60) Provisional application No. 61/289,461, filed on Dec. 23, 2009.

(51) Int. Cl. G09B 19/00; B65D 81/34

(52) U.S. Cl. CPC G09B 19/0092; B65D 81/34
USPC 434/127; 206/457

(57) ABSTRACT

A package is provided for housing consumable products. Methods for teaching children to identify foods to consume and for identifying product brands are also provided. In a general embodiment, the present disclosure provides packages including a body defining a perimeter and at least one interior compartment for housing a consumable product. The perimeter alone, or the perimeter in conjunction with the compartments, forms a shape that is not a typical geometric shape and that is a recognizable shape to a child such as, for example, a ghost or a dog.

### BACKGROUND

The present disclosure relates generally to packaging. More specifically, the present disclosure relates to containers for storing consumable products and methods for teaching children to identify foods to eat and for identifying brands.

Packaging for consumable products come in a variety of sizes, shapes, materials and designs. These sizes, shapes, materials and designs generally differ for example, for aesthetic reasons or marketing purposes. Although consumable product packaging is able to convey different types of information very quickly to a consumer, there does not always exist continuity in the information being conveyed to the consumer.

With all of the different sizes, shapes and designs of packaging found on store shelves, it can be difficult for a consumer to differentiate one product from another. This may complicate the self-feeding process for children who are unable to discern the types of foods contained in the packages. Similarly, problems with differentiating products may also reduce brand loyalty if a consumer is unable to determine whether a product is manufactured by his or her favorite brand.

### SUMMARY

The present disclosure provides a display package housing a plurality of consumable products. In an embodiment, a package includes a body defining a perimeter and at least one interior compartment for housing a consumable product. The perimeter has a shape that is not a typical geometric shape that is a recognizable shape to a child. The recognizable shape may be selected from the group consisting of a ghost a pumpkin, a clown, a doll, a dinosaur, a dog, a cat, a robot, or combinations thereof.

In an embodiment, the body defines two compartments. The body may also define three compartments. The interior compartments may have a shape selected from the group consisting of polygonal semicircular, oblong, or combinations thereof. In an embodiment, the interior compartment has a polygonal shape selected from the group consisting of rectangular, square, triangular, trapezoidal, or combinations thereof.

In an embodiment, the body further defines a hook at a top portion of the package for receiving a hanger. The body may also define a gripping portion.

In an embodiment, the consumable products are selected from the group consisting of snack foods, side meals, full meals, or combinations thereof.

In an embodiment, at least a portion of the perimeter and a portion of a bottom surface of the compartment form a plane to allow the package to stand substantially upright.

In another embodiment, a package includes a body defining a perimeter and at least three compartments for housing consumable products. The perimeter and compartments form a shape that is not a typical geometric shape and that is a recognizable shape to a child. The recognizable shape may be selected from the group consisting of a ghost, a pumpkin, a clown, a doll, a dinosaur, a dog, a cat, a robot, or combinations thereof.

In an embodiment, two of the compartments represent eyes of the recognizable shape. In an embodiment, one of the compartments represents a mouth of the recognizable shape.

In an embodiment, the perimeter further defines a gripping portion. The gripping portion may represent feet of the recognizable shape.

In yet another embodiment, methods for teaching children to identify foods to consumer are provided. The methods include providing a first package having a body defining a perimeter having a shape and at least one compartment housing consumable products. The shape of the perimeter of the body is recognizable to a child and not a typical geometric shape. The methods further include providing a second package having a body defining a perimeter having the same shape as the first package and at least one more compartment than the first package housing consumable products. The methods further include associating the number of compartments in the first and second packages with a type of a meal provided by the first or second packages, and selecting the first or second package for consumption based upon the number of compartments.

In an embodiment, a difference in a number of compartments in the first package and second package is indicative of a difference in the type of food contained in the compartments.

In an embodiment, the methods further include providing a third package comprising a body defining a perimeter having the shape of the first package and the second package and at least one more compartment than the second package housing consumable products.

In an embodiment, the methods further include selecting the first package for consumption for breakfast. The second package may be selected for consumption for lunch. The third package may be selected for consumption for dinner.

In yet another embodiment, methods for identifying a product brand are provided. The methods include providing a first package comprising a body defining a perimeter having a shape and at least one compartment housing consumable products. The shape of the perimeter is recognizable to a child and is not a typical geometric shape. The methods further include providing a second package comprising a body defining a perimeter having the same shape of the first package and at least one compartment housing consumable products. The second package is from about 110% to about 150% larger than the first package. The methods further include associating the shape of the perimeter of the first and second package with a product brand, and selecting the first or second package based on the association of the perimeter shape with the product brand.

In an embodiment, a difference in size of the first package and the second package is indicative of a difference in the consumable products contained therein. The difference in the consumable products contained therein is indicative of a difference in an age group of a child.

In an embodiment, the second package contains consumable products designed for a child that is older than a child for which the consumable products of the first package are designed.

In an embodiment, the methods further include providing a third package having a body defining a perimeter having the shape of the first and second packages and at least one compartment housing consumable products. The third package is from about 110% to about 150% larger than the second package.

In an embodiment, the third package contains consumable products designed for a child that is older than a child for which the consumable products of the second package are designed.

It is an advantage of the present disclosure to provide an improved consumable product container.

It is also an advantage of the present disclosure to provide consumable product containers that are aesthetically pleasing to children.

It is another advantage of the present disclose to provide consumable product containers that teach children to identify proper foods to eat.

It is yet another advantage of the present disclosure to provide consumable product containers that allow consumers to identify product brands.

It is a further advantage of the present disclosure to provide consumable product containers that are easily gripped by children for self feeding.

Additional features and advantages are described herein, and will be apparent from, the following Detailed Description and the figures.

### BRIEF DESCRIPTION OF THE FIGURES

FIG. 1 illustrates a perspective view of a package in an embodiment of the present disclosure.

FIG. 2 illustrates a front view of the package of FIG. 1.

FIG. 3 illustrates a back view of the package of FIG. 1.

FIG. 4 illustrates a side view of the package of FIG. 1.

FIG. 5 illustrates a perspective view of a package standing upright in another embodiment of the present disclosure.

FIG. 6A illustrates a front view of a package in yet another embodiment of the present disclosure.

FIG. 6B illustrates a front view of a package in another embodiment of the present disclosure.

FIG. 6C illustrates a front view of a package in still yet another embodiment of the present disclosure.

### DETAILED DESCRIPTION

The present disclosure provides packages for housing consumable products. Methods for teaching children to identify foods to consume and methods for identifying product brands are also provided. In a general embodiment, packages of the present disclosure include a body that defines a perimeter and at least one interior compartment. The perimeter has a shape that is a recognizable shape to a child that is not a typical geometric shape. In another general embodiment, the perimeter in combination with the interior compartments form a shape that is a recognizable shape to a child that is not a typical geometric shape.

As used herein, a “recognizable shape” means that the perimeter of the package body and/or the perimeter of the body in combination with the compartments forms a shape that is easily recognized by a child. For example, the shape may include, for example, a ghost, a pumpkin, a clown, a doll, a dinosaur, a dog, a cat, a robot, etc. The shape may be recognizable from television, movies, books, plays, games, school, home, etc. Further, as used herein, a “typical geometric” shape is a shape that is commonly known and familiar to children including, for example, a circle, a triangle, a square, a rectangle, etc.

Packages of the present disclosure are designed to house consumable products. The consumable products housed in the packages may be any consumable products including, for example, baby foods, snack foods, full meals, side meals, etc. In an embodiment, the packages house foods for children (e.g., infants, toddlers, pre-schoolers, etc.) including, for example, fruits, vegetables, grains, cereals, pastas, etc. The consumable products may be finger foods or may be designed to be consumed using utensils. The teachings of the present disclosure, therefore, are not dependent upon the consumable products being of any particular type so long as the products fit within the package described herein.

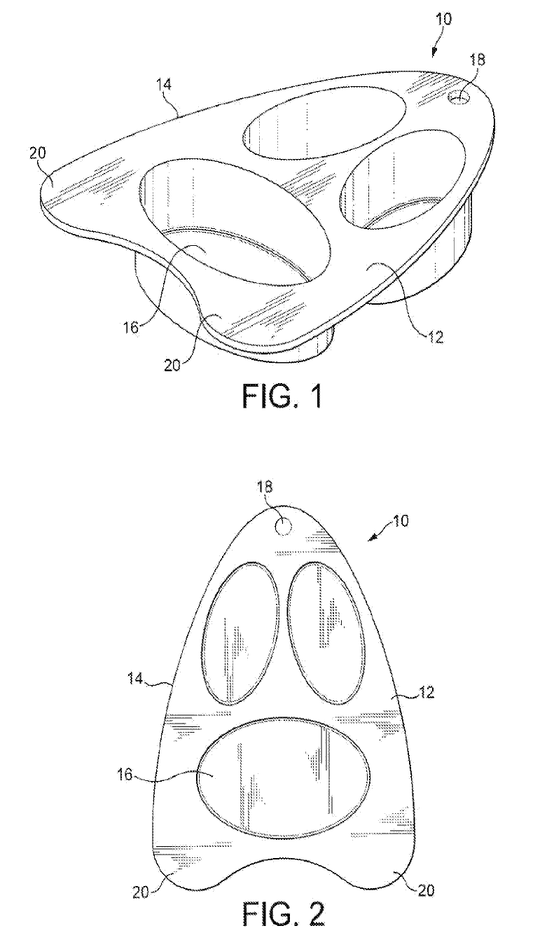

In an embodiment, and as shown in FIG. 1, a package 10 for storing consumable products is provided. Package 10 includes a body 12 that defines a perimeter 14 and at least one interior compartment 16. Body 12 may further define a hook 18 that may be used for hanging package 10 for display. Perimeter 14 of package 10 may define any shape that is easily recognized by a child, but is not a typical geometric shape. For example, in an embodiment illustrated in FIG. 1, perimeter 14 of package 10 defines a ghost shape. However, the skilled artisan will appreciate that the shape of perimeter 14 is not limited to a ghost and may include any shape that is easily recognizable to a child that is not a typical geometric shape.

Package 10 is also not limited to any particular size so long as consumable products may be contained therein. As will be discussed further below, however, the size of package 10 may be indicative of a type of food contained therein. For example, if three packages 10 are provided, each having a different size, the size of each package 10 may indicate whether the package 10 contains breakfast food, lunch food or dinner food. In another embodiment, the size of each package may indicate whether, for example, the package 10 contains a snack food, a side meal or a full meal.

Alternatively, the size of package 10 may be indicative of an age group for which the food contained therein is appropriate. For example, a small package may be designed for infant foods, a medium package may be designed for toddler foods and a large package may be designed for pre-schooler foods. By providing packages 10 having the same shape in different sizes, children are able to determine proper foods to eat for specific meals or depending on age groups, as will be discussed further below. Additionally, by providing packages 10 having the same shape, but different sizes, caretakers may more readily identify a product brand or a proper food for a child of a certain age, as will also be discussed below. The skilled artisan will, appreciate that the dimensions of package 10 may vary as desired or in accordance with manufacturing specifications or in accordance with the size and shape of the consumable products contained therein.

Body 12 further defines at least one compartment 16 that is designed to house consumable products. In an embodiment, body 12 may include one compartment. In another embodiment, body 12 may define more than one compartment. The skilled artisan will appreciate that body 12 may include any number of compartments 16, which will be limited only by the size of package 10. For example, in an embodiment body 12 includes a number of compartments 16 selected from the group consisting of two, three, four, etc.

Compartments 16 may be randomly oriented on body 12 of package 10. In an embodiment, however, compartments 16 may be oriented so as to form a recognizable shape. For example, in an embodiment wherein three compartments are provided, two compartments may represent eyes, one compartment may represent a mouth and a perimeter 14 may represent a general shape of a face or body of a recognizable shape. As shown in FIGS. 1 and 2, a ghost may be defined by perimeter 14 and compartments 16. The skilled artisan will appreciate, however, that any number of recognizable shapes may be formed from perimeter 14 and compartments 16.

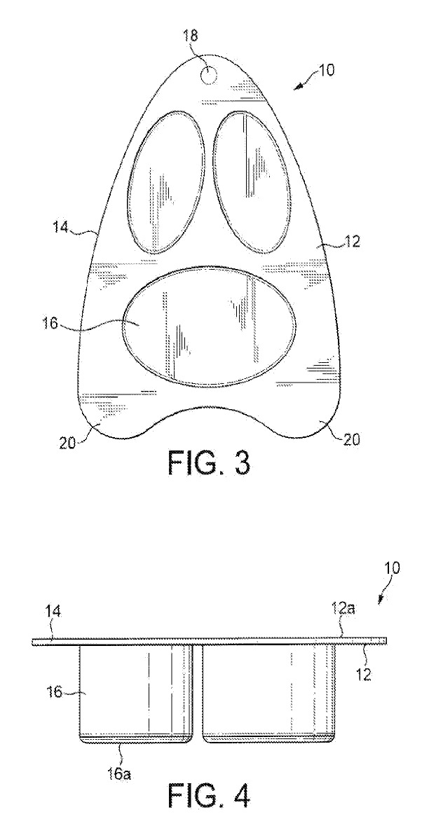

As is shown by FIGS. 3 and 4, compartments 16 may be completely separated so that compartments 16 can house different types of consumable products. For example, a first compartment 16 may house vegetables while a second compartment 16 houses potatoes and a third compartment 16 houses a meat product. Providing different compartments 16 can advantageously protect one type of consumable product from exposure to another. In this manner, compartments 16 can serve as flavor barriers between different flavors of consumable products, thereby preventing flavor migration and homogenization which can otherwise adversely affect product quality.

Perimeter 14 of body 12 may further define a gripping portion 20. Gripping portion 20 may be any portion of perimeter 14 that aids a consumer in handling package 10. For example, in an embodiment wherein package 10 houses consumable products for children, gripping portion 20 aids the child in handling package 10 on his or her own so that the child may learn to self-feed. Accordingly, gripping portion 20 may be especially useful in embodiments wherein the consumable product housed by package 10 is a finger food that a child can consume without the use of utensils.

In an embodiment, gripping portion 20 defines protrusions from perimeter 14 that allow for easier handling of package 10. For exam pie, in FIGS. 1-5, gripping portion 20 of package 10 includes two slightly projecting portions of perimeter 14 that represent feet or a bottom portion of the ghost shape. In an embodiment where gripping portion 20 comprises protrusions from perimeter 14, as in FIGS. 1-5, gripping portion 20 may also be used to aid in standing the product upright for marketing purposes, as will be discussed below. Alternatively, in another embodiment, gripping portion 20 may include a texturized, roughened or raised area (not illustrated) of a surface of body 12.

In an embodiment, gripping portion 20 may be used, at least in part for standing package 10 upright for storage or display. For optimum packaging and shipping to a consumer or to retail stores, it is beneficial that package 10 is able to stand substantially upright. Further, it is advantageous for marketing purposes to display package 10 on a store shelf in a substantially upright position such that a consumer is able to identify a product brand associated with a shape of package 10, the recognizable shape of package 10 is readily visible to the consumer, a child can easily view the shape of package 10, etc.

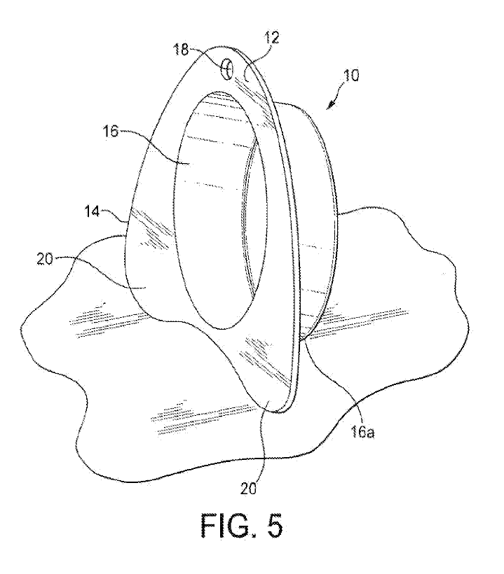

For example, as shown in FIG. 5, gripping portion 20, in combination with a portion of a bottom surface 16a of compartment 16, define a plane on which package 10 stands. Alternatively, a bottom surface 16a of compartment 16 may define two projections (not illustrated) that, in combination with a portion of perimeter 14, form a plane on which package 10 stands. In other words, as long as package 10 defines a plane (i.e., at least three points of contact) on which package 10 can rest, the shape of perimeter 14 and/or compartments 16 is immaterial. In an embodiment, package 10 may rest in a substantially vertical or upright position or may rest in a position that tilts toward or away from a consumer, depending on the shape of package 10. Regardless of the shape of package 10, if intended to rest on its side, package 10 must be able to rest in a stable manner on the plane. In other words, package 10 must be constructed and arranged so that it will not easily fall over when filled with consumable products.

In another embodiment, package 10 nm ay be configured to hang vertically from a display rack in a retail store. As discussed above, body 12 defines a hook 18 that is so constructed and arranged to receive a hanger that allows package to hang from a display rack. The skilled artisan will appreciate that the shape and size of hook 18 is not critical. For example, in an embodiment, hook 18 may be a hole in a top portion of body 12. The hook 18 may be entirely defined by body 12 such that hook 18 does not form part of perimeter 14, as is illustrated at least in FIGS. 1-3.

Alternatively, however, perimeter 14 may include an integral hook 18 (not illustrated) that is so constructed and arranged to form a portion of perimeter 14. In other words, integral hook 18 may be formed continuously with a portion of perimeter 14 such that it shares a boundary with perimeter 14. For example, in an embodiment where package 10 generally has a pumpkin shape (not illustrated), hook 18 may form a portion of perimeter 14 located at a top of package 10 and may have a curved pumpkin stem shape (not illustrated). The skilled artisan will appreciate that hook 18 is not limited to any particular size or shape so long as hook 18 allot a display hanger to pass therethrough to hang package 10.

In addition to standing substantially upright and hanging, package 10 may also be configured to lay substantially flat on a top surface 12a of body 12 or the bottom surface 16a of compartment 16, as shown in FIG. 4. In an embodiment, top surface 12a and bottom surface 16a are substantially flat. In another embodiment, top surface 12a and bottom surface 16a are slightly concave. The skilled artisan will appreciate that top surface 12a and bottom surface 16a need not have the same shape. For example, in an embodiment, one of top surface 12a and bottom surface 16a is flat and the other is slightly concave. Additionally, the skilled artisan will appreciate that top surface 12a and bottom surface 16a need not have only one shape and may have a combination of one or more shapes.

In an embodiment, package 10 may include a lid (not illustrated) or other form of closure such as a removable closure to properly store the consumable products therein. A removable closure (not shown) such as, for example, a transparent film or a lid stock, may be sealed onto top surface 12a of body 12 and may sealably separate the contents of each compartment 16 in embodiments where more the one compartment 16 is provided. In addition to separation of consumable products, the removable closure may also be used to keep the products fresh and to extend the shelf life of the products. Any conventional sealing technique known in the art may be used to seal the removable closure onto top surface 12a of body 12. The techniques may include, but are not limited to, conductive heating, cold sealing, heat sealing, heat activated adhesive, etc.

Package 10 may be made from a molded plastic material such as, for example, polyethylene, polypropylene, or the like, or combinations thereof. Body 12 may be formed using conventional thermoforming or molding processes including, but not limited to, injection molding, injection blow molding and extrusion blow molding. Alternatively, package 10 may be manufactured from non-plastic materials including, but not limited to, cardboard, metal, styrofam, etc. Further, at least a portion of package 10 can be either transparent or translucent so that a consumer can readily discern what types of products are housed in compartment 16 of package 10. Alternatively, at least a portion of package 10 may be opaque. In an embodiment wherein a lid (not illustrated) is provided, the lid may be translucent while body 12 is opaque.

In addition to having different optical properties, package 10 may also have different colors. Package 10 may have a color selected from the group consisting of white, yellow, orange, red, green, blue, purple, brown, black, etc. For example, in an embodiment, package 10 may be transparent and red in color. Alternatively, package 10 may be opaque and blue in colors. In an embodiment, package 10 of FIG. 1 may be opaque and white in color such that the ghost shape is more easily recognized by a child. In another embodiment, package 10 may be shaped like a pumpkin, include three substantially triangular-shaped compartments that represent two eyes and a mouth, be orange in color and have an integral hook portion that is green in color and shaped like a pumpkin stem. The skilled artisan will appreciate that the optical properties and colors of package 10 are not limiting and that package 10 may have any combination thereof.

Package 10 may include indicia (not illustrated) provided on an exterior and/or interior of body 12 for marketing purposes. The indicia may include, for example, logos, advertisements, branding information, nutritional information, product information, manufacturer information, etc. The indicia may be printed on a pressure sensitive material, printed directly on package 10, printed on a removable closure, etc.

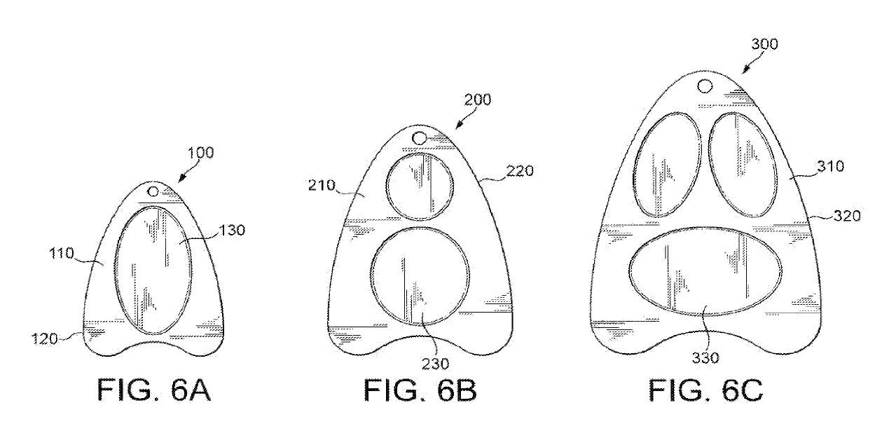

In an embodiment, methods for using packages of the present disclosure are also provided. For example, in an embodiment, methods for teaching children to identify foods to eat are provided. The methods include providing a first package 100, as shown in FIG. 6A, having a body 110 defining a perimeter 120 and at least one compartment 130 housing consumable products. Similar to previous embodiments, perimeter 120 defines a recognizable shape to a child that is not a typical geometric shape. The methods further include providing a second package 200, as shown in FIG. 61, having a body 210 defining a perimeter 220 having the same shape of the first package 100 and at least one more compartment 230 than the first package 100, which also houses consumable products. The methods include associating the number of compartments 130, 230 in first and second packages 100, 200 with a type of a meal provided by first or second packages 100, 200, and selecting first or second package 100, 200 for consumption based upon the number of compartments 130, 230.

In another embodiment, a third package 300 is provided, as illustrated in FIG. 6C. The third package 300 may also include a body 310 defining a perimeter 320 having the shape of the first package 100 and the second package 200, and at least one more compartment than the second package 200, which also houses consumable products.

As discussed above, the skilled artisan will appreciate that the packages of the present disclosure are not limited by the number of compartments contained therein. Indeed, the packages of the present invention may include any number of compartments. By providing a different number of compartments for packages of the present invention, children may be able to associate the number of compartments with a type of food contained therein such that the child will be able to easily determine which meal is appropriate or desired for consumption.

For example, package 100 of FIG. 6A may contain a breakfast meal, while package 200 of FIG. 6G may contain a lunch meal and package 300 of FIG. 6C may contain a dinner meal. Similarly, package 100 may contain a snack food (e.g., pretzels, crackers, nuts, etc.), while package 200 contains a side meal (e.g., mashed potatoes, macaroni and cheese, cheese and crackers, etc.) and package 300 contains a full meal (e.g., meat, potatoes and a vegetable). Depending on the time of day (e.g., breakfast, lunch or dinner) or the hunger level of a child (e.g., snack, side meal or full meat), the child may associate the number of compartments with an appropriate meal and select a package for consumption depending on same.

Similarly, packages 100, 200 and 300 may all contain foods designed for the same age group (e.g., one of an infant, toddler, or pre-schooler) and children may become familiar with the types of foods contained in different packages of the present disclosure. For example, package 100 may contain a pre-schooler meal comprising one type of food such as, for example, a pasta (e.g., ravioli), while package 200 may contain a 2-food pre-schooler meal comprising, for example, a cheese in one compartment and a meat in another compartment, and while package 300 may contain a 3-food pre-schooler meal comprising, for example, meat, potatoes and a vegetable. Based on the child's desires, child can select a meal appropriate fbr his or her tastes.

Alternatively, a number of compartments of packages of the present disclosure may help caretakers and/or children identify which package contains foods that are appropriate for children of different age groups. For example, package 100 may contain a food designed for an infant, while package 200 may contain a food designed for a toddler and package 300 may contain a food designed for a pre-school-aged child. Such a packaging system will advantageously help caretakers quickly and easily identify age-appropriate foods while shopping in a retail store or supermarket, or while preparing meals at home.

Accordingly, a difference in a number of compartments of packages of the present disclosure may be indicative of a number of factors including, for example, foods appropriate for an age category and types of foods contained in the packages.

In another embodiment, methods for identifying product brands are provided. The methods include providing a first package 100, as shown in FIG. 6A, having a body 110 defining a perimeter 120 having a shape and at least one compartment 130 housing consumable products. As discussed above, perimeter 120 defines a recognizable shape to a child that is not a typical geometric shape. The methods further include providing a second package 200, as shown in FIG. 6B, having a body 210 defining a perimeter 220 having the same shape as the first package 100 and at least one compartment 230 housing consumable products. Second package 220, however, may be from about 110% to about 150% larger than first package 100. The methods also include associating the shape of perimeter 120, 220 of first and second packages 100, 200 with a product brand and selecting first or second package 100, 200 based on the association of the perimeter shape with the product brand.

In another embodiment, a third package 300 is provided, as shown in FIG. 6C, that includes a body 310 defining a perimeter 320 having the shape of the first and second packages 100, 200 and at least one compartment 330 housing consumable products. Third package 300, however, may be from about 110% to about 150% larger than second package 200.

The skilled artisan will appreciate that the differences in sizes between packages of the present disclosure is not limited. For example, second package 200 may be from 110% to about 200% larger than first package 100. In another embodiment, second package 200 may be from about 130% to about 180% larger than first package 100. In an embodiment, second package 200 is about 150% larger than first package 100.

The skilled artisan will also appreciate that third package 300 may be from 110% to about 200% larger than second package 200. In another embodiment, third package 300 may be from about 130% to about 180% larger than second package 200. In an embodiment, third package 300 is about 150% larger than second package 200.

Similarly, third package 300 may be from 110% to about 200% larger than first package 100. In another embodiment, third package 300 may be from about 130% to about 180% larger than first package 100. In an embodiment, third package 300 is about 150% larger than first package 100.

By providing a system of packages that have the same shapes but different sizes, a consumer may quickly and easily identify a product brand. This may be advantageous because, although infant foods, toddler foods and pre-schooler foods are not always situated next to each other on shelves or sorted by brand names, a consumer familiar with one size of the package system will quickly and easily identify another package having the same shape, but a different size that is designed for a different age group.

For example, package 100 may contain a food designed for an infant, while package 200 may contain a food designed for a toddler and package 300 may contain a food designed for a pre-school-aged child. Therefore, a parent of both an infant and a pre-schooler, who is, for example, familiar with package 100 for infant foods will be able to quickly and easily identify a pre-schooler meal in package 300 that is manufactured by the same brand as package 100. Such a packaging system will advantageously promote brand recognition and loyalty with consumers, in addition to making the consumer shopping experience more efficient.

Similarly, such a system will also provide continuity for products designed for children of the same age group, but containing different types of foods. For example, package 100 may contain a small-sized pre-schooler meal, while package 200 may contain a medium-sized pre-schooler meal, and while package 300 may contain a large-sized pre-schooler meal. Based on the child's desires, child can select a meal appropriate for his or her tastes. In embodiments wherein the shape of the package is the same, but the size of the packages are different, packages may have the same number of compartments or different numbers of compartments.

In addition, and as discussed previously with respect to the number of compartments, providing packages of different sizes may also help consumers to quickly and easily identify which package contain foods that are appropriate for children of different age groups. In an embodiment, small first package 100 may contain a food designed for an infant, while medium second package 200 may contain a food designed for a toddler, and a large third package 300 may contain a food designed for a pre-school-aged child.

Accordingly, a difference in the size of packages of the present disclosure, which all have the same shape may be indicative of a number of factors including, for example, a common product brand, types of foods contained in the packages and age groups for which foods contained in the packages are appropriate.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A package comprising:
a body defining a perimeter and at least one interior compartment for housing a consumable product, the perimeter having a shape, other than a typical geometric shape, that is a recognizable shape to a child.

2. The package of claim 1, wherein the recognizable shape is selected from the group consisting of a ghost, a pumpkin, a clown, a doll, a dinosaur, a dog, a cat, a robot, and combinations thereof.

3. The package of claim 1, wherein the body defines two compartments.

4. The package of claim 1, wherein the body defines three compartments.

5. The package of claim 1, wherein the interior compartment has a shape selected from the group consisting of polygonal, semi-circular, oblong, and combinations thereof.

6. The package of claim 5, wherein the interior compartment has a polygonal shape selected from the group consisting of rectangular, square, triangular, trapezoidal, and combinations thereof.

7. The package of claim 1, the body further defining a hook at a top portion of the package for receiving a hanger.

8. The package of claim 1, wherein the consumable products are selected from the group consisting of snack foods, side meals, full meals, and combinations thereof.

9. The package of claim 1, wherein the perimeter further defines a gripping portion.

10. The package of claim 1, wherein at least a portion of the perimeter and a portion of a bottom surface of the compartment form a plane to allow the package to stand substantially upright.

11. A package comprising:
a body defining a perimeter and at least three compartments for housing consumable products, the perimeter and compartments forming a shape, other than a typical geometric shape, that is a recognizable shape to a child.

12. The package of claim 11, wherein the recognizable shape is selected from the group consisting of a ghost, a pumpkin, a clown, a doll, a dinosaur, a dog, a cat, a robot, and combinations thereof.

13. The package of claim 11, wherein two of the compartments represent eyes of the recognizable shape.

14. The package of claim 11, wherein one of the compartments represents a mouth of the recognizable shape.

15. The package of claim 11, wherein the perimeter further defines a gripping portion.

16. The package of claim 15, wherein the gripping portion represents feet of the recognizable shape.

17. A method for teaching children to identify foods to consume, the method comprising:
providing a first package comprising a body defining a perimeter having a shape and at least one compartment housing consumable products, the shape being recognizable to a child and not a typical geometric shape;
providing a second package comprising a body defining a perimeter having the same shape as the first package and at least one more compartment than the first package housing consumable products;
associating the number of compartments in the first and second packages with a type of a meal provided by the first or second packages; and
selecting the first or second package for consumption based upon the number of compartments.

18. The method of claim 17, wherein a difference in a number of compartments in the first package and second package is indicative of a difference in the type of food contained in the compartments.

19. The method of claim 17, further comprising selecting the first package for consumption for breakfast.

20. The method of claim 17, further comprising selecting the second package for consumption for lunch.

21. The method of claim 17, further comprising providing a third package comprising a body defining a perimeter having the shape of the first package and the second package and at least one more compartment than the second package housing consumable products.

22. The method of claim 21, further comprising selecting the third package for consumption for dinner.

23. A method for identifying a product brand, the method comprising:
providing a first package comprising a body defining a perimeter having a shape and at least one compartment housing consumable products, the shape being recognizable to a child and not a typical geometric shape;
providing a second package comprising a body defining a perimeter having the same shape of the first package and at least one compartment housing consumable products, wherein the second package is from about 110% to about 150% larger than the first package;
associating the shape of the perimeter of the first and second packages with a product brand; and
selecting the first or second package based on the association of the perimeter shape with the product brand.

24. The method of claim 23, wherein a difference in size of the first package and the second package is indicative of a difference in the consumable products contained therein.

25. The method of claim 24, wherein the difference in the consumable products contained therein is indicative of a difference in an age group of a child.

26. The method of claim 23, wherein the second package contains consumable products designed for a child that is older than a child for which the consumable products of the first package are designed.

27. The method of claim 23, further comprising providing a third package comprising a body defining a perimeter having the shape of the first and second packages and at least one compartment housing consumable products, wherein the third package is from about 110% to about 150% larger than the second package.

28. The method of claim 27, wherein the third package contains consumable products designed for a child that is older than a child for which the consumable products of the second package are designed.
